(19) United States
(12) Patent Application Publication
(10) Pub. No.: US 2026/0136311 A1
(43) Pub. Date: May 14, 2026

(54) SYSTEMS AND METHODS FOR SYNCHRONIZATION SIGNAL BLOCK (SSB) ENHANCEMENT

(71) Applicant: ZTE CORPORATION, Shenzhen, Guangdong (CN)

(72) Inventors: Wei CAO, Shenzhen (CN); Shuang ZHENG, Shenzhen (CN); Hanqing XU, Shenzhen (CN); Nan ZHANG, Shenzhen (CN)

(73) Assignee: ZTE CORPORATION, Shenzhen, Guangdong (CN)

(21) Appl. No.: 19/407,440

(22) Filed: Dec. 3, 2025

Related U.S. Application Data
(63) Continuation of application No. PCT/CN2023/100507, filed on Jun. 15, 2023.

(51) Int. Cl. H04W 56/00; H04W 24/10; H04W 72/231

(52) U.S. Cl. CPC H04W 56/0015; H04W 24/10; H04W 72/231

(57) ABSTRACT

Presented are systems and methods for synchronization signal block (SSB) enhancement. A wireless communication device (e.g., a UE) may receive a supplemental synchronization signal block (SSB) measurement timing configuration (SMTC) (e.g., SMTC5) from a wireless communication node (e.g., a BS). The wireless communication device may perform measurement of at least one of a plurality of SSBs according to the supplemental SMTC. The wireless communication device may send at least one report of the measurement to the wireless communication node.

### CROSS-REFERENCE TO RELATED APPLICATION

This application claims the benefit of priority under 35 U.S.C. § 120 as a continuation of PCT Patent Application No. PCT/CN2023/100507, filed on Jun. 15, 2023, the disclosure of which is incorporated herein by reference in its entirety.

### TECHNICAL FIELD

The disclosure relates generally to wireless communications, including but not limited to systems and methods for synchronization signal block (SSB) enhancement.

### BACKGROUND

The standardization organization Third Generation Partnership Project (3GPP) is currently in the process of specifying a new Radio Interface called 5G New Radio (5G NR) as well as a Next Generation Packet Core Network (NG-CN or NGC). The 5G NR will have three main components: a 5G Access Network (5G-AN), a 5G Core Network (5GC), and a User Equipment (UE). In order to facilitate the enablement of different data services and requirements, the elements of the 5GC, also called Network Functions, have been simplified with some of them being software based, and some being hardware based, so that they could be adapted according to need.

### SUMMARY

The example embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, example systems, methods, devices and computer program products are disclosed herein. It is understood, however, that these embodiments are presented by way of example and are not limiting, and it will be apparent to those of ordinary skill in the art who read the present disclosure that various modifications to the disclosed embodiments can be made while remaining within the scope of this disclosure.

At least one aspect is directed to a system, method, apparatus, or a computer-readable medium of the following. A wireless communication device (e.g., a UE) may receive a supplemental synchronization signal block (SSB) measurement timing configuration (SMTC) (e.g., SMTC5) from a wireless communication node (e.g., a BS). The wireless communication device may perform measurement of at least one of a plurality of SSBs (e.g., transmitted by a communication node) according to the supplemental SMTC. The wireless communication device may send at least one report of the measurement to the wireless communication node. Enable multiple measurements (from different communication nodes) for a single SSB may reuse the SSB indexes and may have less impact on a SSB mapping to other associated common channels.

In some embodiments, the SSBs can be transmitted by a communication node (e.g., located between the wireless communication node or a base station, and at least one wireless communication device or user equipment) configured to at least one of: receive, amplify, send or forward at least one SSB from the wireless communication node. The SSBs, and at least one SSB from the wireless communication node, may have transmission occasions that are interleaved in time domain (e.g., over a number of periodic cycles). In some embodiments, the SSBs can be forwarded by a NCR and can be time division multiplexed (TDMed) with non-forwarded SSBs. The TDMed SSBs may allow separate measurements of a SSB with a same SSB index.

In some embodiments, the supplemental SMTC may further comprise at least one of: a list of offsets; an identification of one or more of the SSBs; or an association between the offsets and the one or more of the SSBs to be measured. To enable the measurement for a single SSB from different beams, a SMTC5 may comprise at least one of: a list of offsets; an identification of one or more of the SSBs; or an association between the offsets and the one or more of the SSBs to be measured. In some embodiments, the supplemental SMTC may indicate or configure that: the list of offsets can be applied to the one or more of the SSBs; or a respective list of offsets can be applied to each of the one or more of the SSBs.

In some embodiments, the wireless communication device may receive a first SMTC (e.g., SMTC1) from the wireless communication node. The first SMTC may comprise an indication of at least one of: at least one offset of a SSB from (e.g., transmitted/sent from) the wireless communication node; or a periodicity of the SSB from the wireless communication node. The periodicity can be same as that of the plurality of SSBs, the plurality of SSBs can be from a network node; or the supplemental SMTC may exclude an indication of the periodicity of the plurality of SSBs.

In some embodiments, the report may include a list (e.g., MeasQuantityResultsList->MeasQuantityResults) which includes one or more measurements results for each of the SSBs that is identified in the supplemental SMTC for measurement. Each of one or more measurements results for one of the SSBs (e.g., a first SSB) can be associated with offsets of the one of the SSBs (e.g., the first SSB) in a sequential manner. A maximum number of offsets applicable to a single SSB can be configured via a defined parameter (e.g., maxNrofOffsets). The list may include one or more measurements results that each meets a defined threshold for measurement reporting. The report may include an indication of one of more offsets corresponding to the one or more measurements results that each meets (e.g., satisfies, exceeds) the defined threshold. The list may include a maximum number of measurements results that is at most equal to a total number of offsets for a SSB provided by a first SMTC (e.g., SMTC1) and the supplemental SMTC (e.g., SMTC5).

In some embodiments, each of the SSB may include/comprise/be a respective common signal. The common signal may comprise at least one of: a synchronization signal/physical broadcast channel block, a control resource set (CORESET), a system information block (SIB), random access channel signal, or a paging signal. A number of measurement results in the report may correspond to a minimum number between: a number of unique offsets for a SSB, and a number of measurement results for the SSB exceeding a defined threshold for measurement reporting.

In some embodiments, a communication node (e.g., a NCR-MT) can be configured with a periodicity for SSBs of the communication node, that is different from (e.g., 20 ms or 10 ms) a periodicity of a SSB of the wireless communication node. The communication node may determine offsets for the SSBs of the communication node, according to the periodicity for the SSBs of the communication node. The communication node may perform measurement of the SSBs of the communication node, using the determined offset and the configured periodicity. The communication node may receive a configuration comprising: the configured periodicity (e.g., ncr-ssb-periodicityServingCell), and an identification of one or more of the SSBs to be measured (e.g., ssb-ToMeasure) by the communication node, to which the configured periodicity applies. In some embodiments, the identification may comprise a bitmap with each bit indicating whether a corresponding SSB is to be measured. A bitwidth (e.g., number of bits) of the bitmap can be a total number of SSBs of the wireless communication node. The bitmap may comprise bits corresponding in sequence to indexes of the one or more SSBs.

In some embodiments, the identification may comprise indexes of the one or more SSBs is to be measured. A maximum number of the indexes of the one or more SSBs can be to be measured, is same as a number of SSBs transmitted by the wireless communication node. The communication node may receive one or more parameters of the configuration from the wireless communication node via at least one of: a radio resource control (RRC) signaling, a medium access control control element (MAC CE) signaling, a downlink control information (DCI) signaling, or an operations, administration and maintenance (OAM) signaling. The configuration may include an indication of a number of valid SSBs, which identifies first or last SSBs in order of their indexes, that are valid. In some embodiments, the communication node may determine the offsets using a modulo function (e.g., mod(offset provided in periodicityAndOffset, ncr-ssb-periodicityServingCell)) applied on: an offset provided in a periodicityAndOffset parameter, and the configured periodicity.

In some embodiments, a wireless communication node (e.g., a BS) may send a supplemental synchronization signal block (SSB) measurement timing configuration (SMTC) (e.g., SMTC5) to a wireless communication device (e.g., a UE). The wireless communication node may receive at least one report of measurement performed by the wireless communication device of at least one of a plurality of SSBs, according to the supplemental SMTC, from wireless communication device.

### BRIEF DESCRIPTION OF THE DRAWINGS

Various example embodiments of the present solution are described in detail below with reference to the following figures or drawings. The drawings are provided for purposes of illustration only and merely depict example embodiments of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1 illustrates an example cellular communication network in which techniques disclosed herein may be implemented, in accordance with an embodiment of the present disclosure;

FIG. 2 illustrates a block diagram of an example base station and a user equipment device, in accordance with some embodiments of the present disclosure;

FIG. 3 illustrates an example implementation of a network controlled repeater (NCR), in accordance with some embodiments of the present disclosure;

FIG. 4 illustrates an example initial access of user equipments (UEs), in accordance with some embodiments of the present disclosure;

FIG. 5 illustrates an example extended synchronization signal block (SSB) periodicity from a view point of a user equipment (UE), in accordance with some embodiments of the present disclosure;

FIG. 6 illustrates an example structure for synchronization signal block (SSB) enhancement, in accordance with some embodiments of the present disclosure;

FIG. 7 illustrates an example network controlled repeater (NCR)-specific synchronization signal block (SSB) pattern, in accordance with some embodiments of the present disclosure;

FIG. 8 illustrates an example network controlled repeater (NCR)-specific synchronization signal block (SSB) pattern, in accordance with some embodiments of the present disclosure;

FIG. 9 illustrates an example network controlled repeater (NCR)-specific synchronization signal block (SSB) pattern, in accordance with some embodiments of the present disclosure;

FIG. 10 illustrates an example network controlled repeater (NCR)-specific synchronization signal block (SSB) pattern, in accordance with some embodiments of the present disclosure; and

FIG. 11 illustrates a flow diagram for synchronization signal block (SSB) enhancement, in accordance with an embodiment of the present disclosure.

### DETAILED DESCRIPTION

### 1. Mobile Communication Technology and Environment

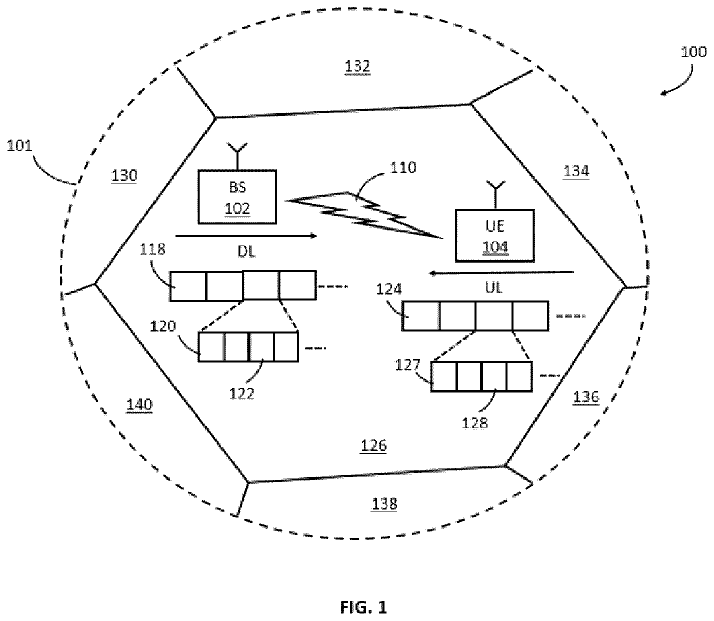

FIG. 1 illustrates an example wireless communication network, and/or system, 100 in which techniques disclosed herein may be implemented, in accordance with an embodiment of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”; also referred to as wireless communication node) and a user equipment device 104 (hereinafter “UE 104”; also referred to as wireless communication device) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various embodiments of the present solution.

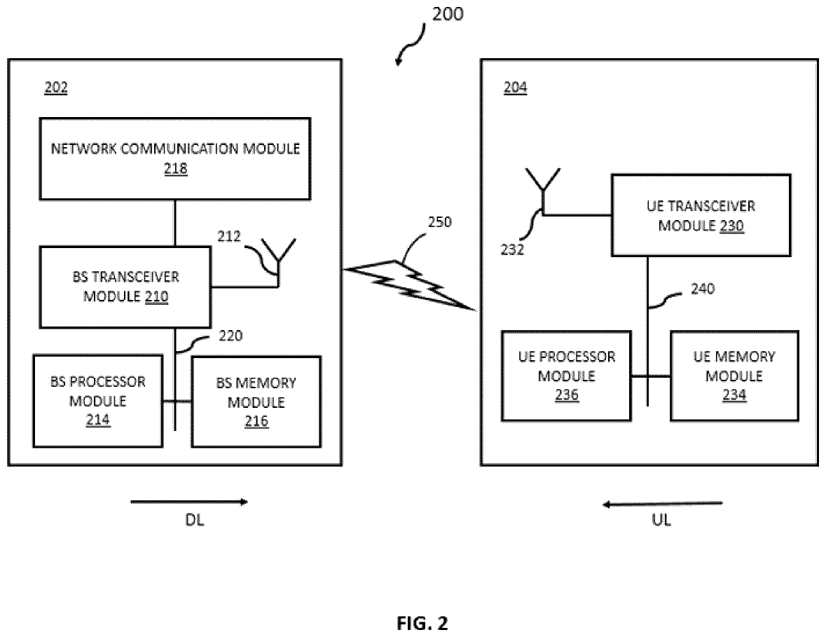

FIG. 2 illustrates a block diagram of an example wireless communication system 200 for transmitting and receiving wireless communication signals (e.g., OFDM/OFDMA signals) in accordance with some embodiments of the present solution. The system 200 may include components and elements configured to support known or conventional operating features that need not be described in detail herein. In one illustrative embodiment, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some embodiments, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some embodiments, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 may be coordinated in time such that the uplink receiver circuitry is coupled to the uplink antenna 232 for reception of transmissions over the wireless transmission link 250 at the same time that the downlink transmitter is coupled to the downlink antenna 212. Conversely, the operations of the two transceivers 210 and 230 may be coordinated in time such that the downlink receiver is coupled to the downlink antenna 212 for reception of transmissions over the wireless transmission link 250 at the same time that the uplink transmitter is coupled to the uplink antenna 232. In some embodiments, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative embodiments, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various embodiments, the BS 202 may be an evolved node B (eNB), a serving eNB, a target eNB, a femto station, or a pico station, for example. In some embodiments, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some embodiments, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

The Open Systems Interconnection (OSI) Model (referred to herein as, “open system interconnection model”) is a conceptual and logical layout that defines network communication used by systems (e.g., wireless communication device, wireless communication node) open to interconnection and communication with other systems. The model is broken into seven subcomponents, or layers, each of which represents a conceptual collection of services provided to the layers above and below it. The OSI Model also defines a logical network and effectively describes computer packet transfer by using different layer protocols. The OSI Model may also be referred to as the seven-layer OSI Model or the seven-layer model. In some embodiments, a first layer may be a physical layer. In some embodiments, a second layer may be a Medium Access Control (MAC) layer. In some embodiments, a third layer may be a Radio Link Control (RLC) layer. In some embodiments, a fourth layer may be a Packet Data Convergence Protocol (PDCP) layer. In some embodiments, a fifth layer may be a Radio Resource Control (RRC) layer. In some embodiments, a sixth layer may be a Non Access Stratum (NAS) layer or an Internet Protocol (IP) layer, and the seventh layer being the other layer.

Various example embodiments of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example embodiments and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

### 2. Systems and Methods for Synchronization Signal Block (SSB) Enhancement

As a new radio (NR) system moves to higher frequencies (e.g., around 4 GHz for frequency range 1 (FR1) deployments, above 24 GHz for frequency range 2 (FR2) deployments), propagation conditions degradation as compared to lower frequencies exacerbates coverage challenges. As a result, further densification of cells may be necessary. While a deployment of regular full-stack cells is preferred, the deployment may not always be a possible (e.g., no availability of backhauls) and/or economically viable option. To provide a blanket coverage in cellular network deployments with relatively low cost, radio frequency (RF) repeaters with full-duplex amplify-and-forward operation can be used in 2G, 3G and 4G systems. However, a RF repeater without beam management functions may not be efficient for a 5G NR system, which may even lead to unwanted interference. To cope/deal/manage with the above problems, a network controlled repeater (NCR) or a reconfigurable intelligent surface (RIS) can be considered, which may make use of side control information (SCI) from a BS to enable an intelligent amplify-and-forward or reflecting operation.

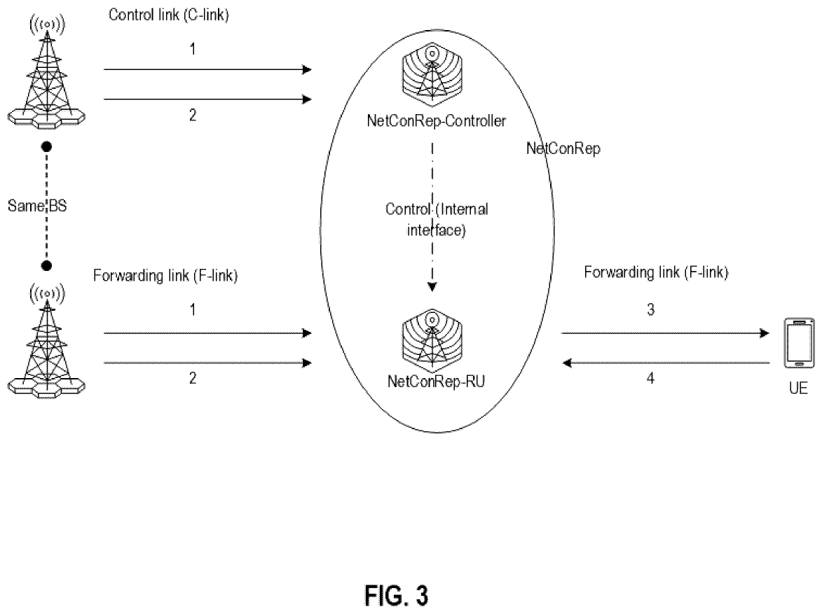

From the perspective of functionality, a general structure of a NCR (e.g., as an alternative/improvement to RF repeaters) is provided in FIG. 3. A NCR-Controller may maintain a control link (C-link) between a BS and a NCR to enable information exchanges (e.g., carrying side control information (SCI)). A NCR-Forward may use a forwarding link (F-link), which can refer to an F-link for backhaul (e.g., F-links 1 & 2 or backhaul link) and an F-link for access (e.g., F-links 3 & 4 or access link), to forward data between a BS and UE(s). The behavior of F-link(s) can be controlled according to received SCI from the BS.

Since the NCR or RIS transparently forwards the signal received from the BS, there may be following problems from viewpoints of both BS and UEs.

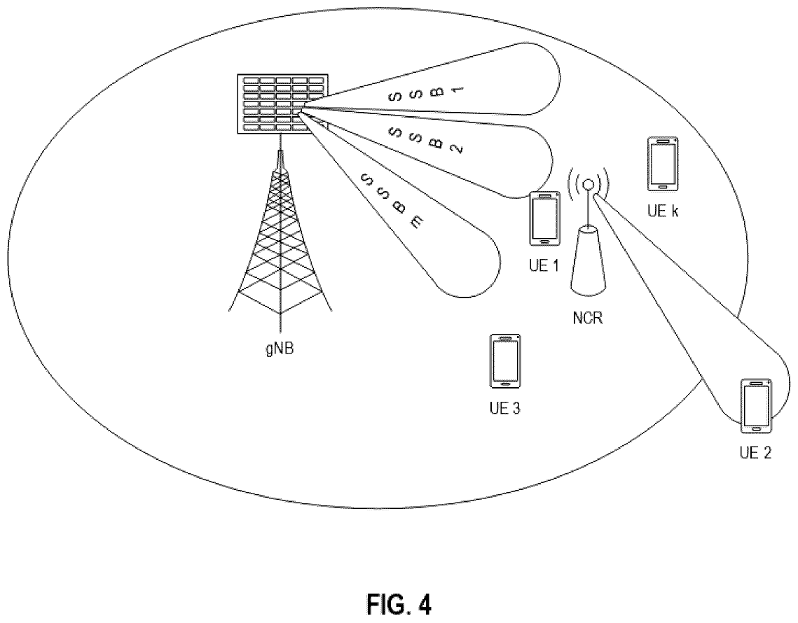

Problem 1: From the viewpoint of a BS, the problem can be how to determine whether UE is served by a BS or a NCR. As illustrated in FIG. 4, in a cell search procedure, a UE may acquire a DL synchronization via a reception of SSBs. The DL beam used by a UE can be determined by random access channel (RACH) and synchronization signal block (SSB) measurements. In FIG. 4, it is possible that UE 1 and UE 2 report the same index of SSB (e.g., SSB2) as the optimal DL beam. As a result, the BS cannot determine whether the UE is served by the BS directly (e.g., UE 1) or by the NCR (e.g., UE 2). Consequently, (1) the BS may indicate the NCR to perform unnecessary forwarding for the UE1 and extra interference is introduced in the coverage area, or (2) the BS cannot correctly indicate the NCR to forward a signal for the UE2 and this can cause poor connection for UE2. Furthermore, the UEs in RRC_CONNECTED status may move and lead to beam switching among the BS and NCRs. To support the UE mobility, it may be necessary to consider the corresponding beam measurement with the presence of NCRs.

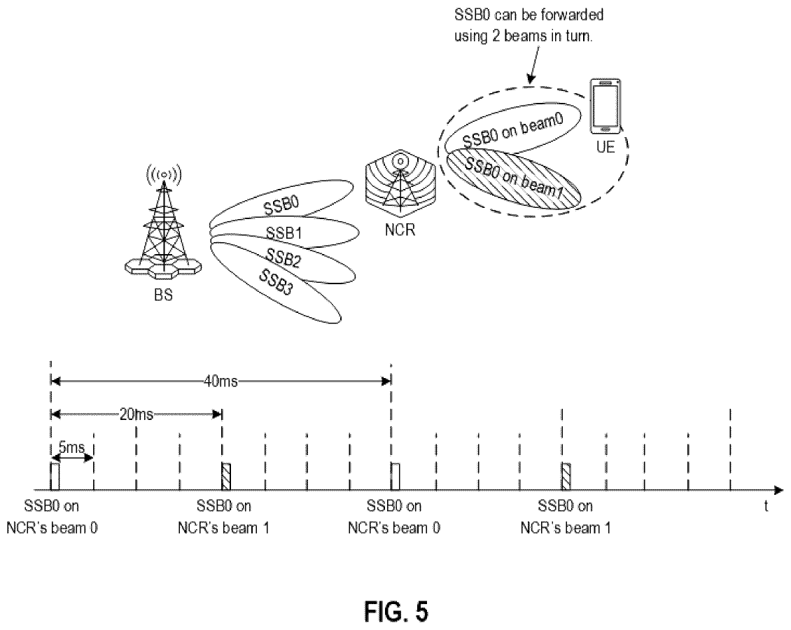

Problem 2: From the viewpoint of a UE, common periodic signals may have an extended periodicity. Since the NCR generally has multiple beams, the common periodic signals may face the problem of an extended periodicity. Taking the SSB forwarding as an example, the BS may transmit a SSB with 20 ms period. The BS may indicate the NCR to forward the SSB0 as illustrated in FIG. 5. The NCR may have two beams and can utilize them alternatively to forward SSB0. Since the UE is served by one of the NCR's beam, the periodicity of the received SSB0 may have 40 ms from the viewpoint of the UE, whereas the SSB periodicity indicated in SIB1 is 20 ms. In such case, the L1 SSB measurement can be inaccurate.

To solve the problems mentioned above, the present disclosure provides a method for SSB enhancement for a wireless network with a NCR/RIS.

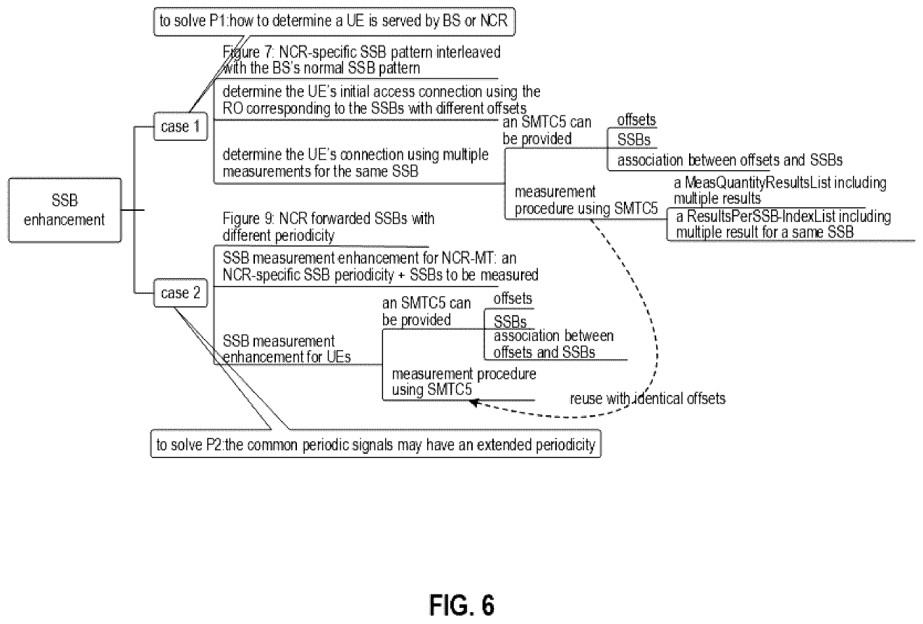

In FIG. 6, RF repeaters can be used in 2G, 3G and 4G deployments to supplement coverage provided by regular full-stack cells with various transmission power characteristics. The RF repeaters may constitute the simplest and most cost-effective way to improve network coverage. The main advantages of RF repeaters can be low-cost, ease of deployment, and the fact that the RF repeaters may not increase latency. The main disadvantage can be that the RF repeaters can amplify signal and noise. Hence, the RF repeaters may contribute to an increase of interference (e.g., signal pollution) in the system. Within RF repeaters, there can be different categories depending on power characteristics and an amount of spectrum that the RF repeaters can be configured to amplify (e.g., single band, or multi-band). The RF repeaters can be a non-regenerative type of relay nodes, and can simply amplify-and-forward signal in an omnidirectional way.

FIG. 3 illustrates an example implementation of a network controlled repeater (NCR), in accordance with some embodiments of the present disclosure. The transmission links between the BS to NCR and the NCR to UE as shown in FIG. 3 can be defined/described/provided as follows:
C-link 1: Control link from BS to NCR CU;
C-link 2: Control link from NCR CU to BS;
F-link 1: Forwarding link from BS to NCR FU;
F-link 2: Forwarding link from NCR FU to BS;
F-link 3: Forwarding link from NCR FU to UE; and
F-link 4: Forwarding link from UE to NCR FU.

The forwarding operation on the F-link 1 & 2 (backhaul link) can reuse the resource information and indication mechanism for the C-link. The forwarding operation on the F-link 3 & 4 (access link) may use dedicated resource information and indication mechanism.

A reconfigurable intelligent surface (RIS) can be a programmable structure that can be used to control propagation of electromagnetic waves by changing electric and magnetic properties of surfaces. By placing these surfaces in an environment, the properties of radio channels can be controlled. Similar to the network controlled repeater (NCR), a RIS-Controller can be utilized to receive side control information from a BS to properly manipulate a signal reflection.

To solve the problems mentioned above, following implementation examples/cases can be described with corresponding methods.

### Implementation Example 1: To Determine Whether a UE is Served by a BS or a NCR

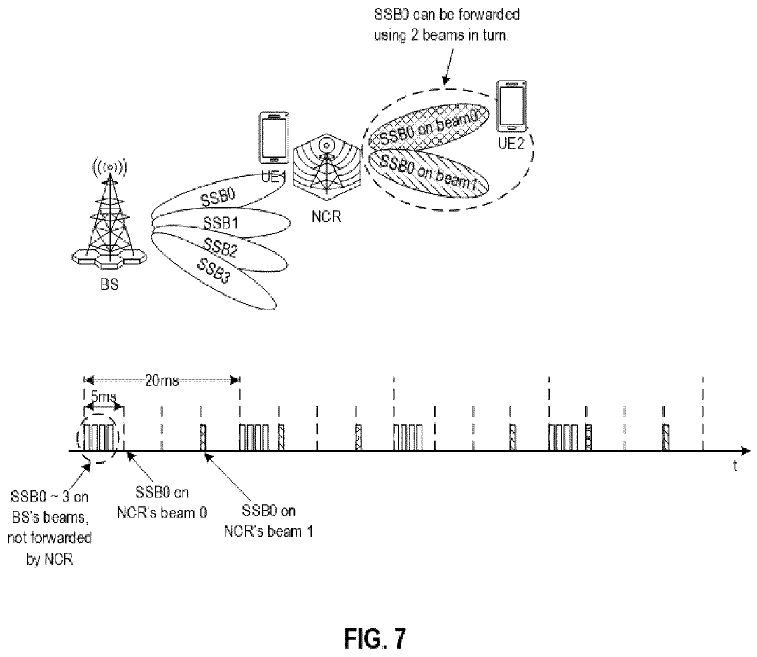

To solve the problem 1, two aspects can be considered. One is a UE's connection determination in an initial access stage. The other is a beam measurement to support a UE's mobility among a BS and NCRs. An NCR-specific SSB pattern can be adopted, which can be interleaved with a normal SSB pattern of the BS in a time domain. An example is provided in FIG. 7. FIG. 7 illustrates an example network controlled repeater (NCR)-specific synchronization signal block (SSB) pattern interleaved with a normal SSB pattern of the BS, in accordance with some embodiments of the present disclosure.

In the normal SSB pattern of the BS, the SSB 0˜3 can be transmitted without a NCR's forwarding, which may use a periodicity of 20 ms. From the viewpoint of the UE1 in the serving area of the BS, the periodicity of the SSB0 can be 20 ms. The UE1 can be provided by ssb-periodicityServingCell of 20 ms to receive the SSBs. The ssb-periodicityServingCell can be provided in system information (e.g., SIB1), or a UE-specific configuration.

To support coverage enhancement for the NCR's serving area, an extra NCR-specific SSB pattern can be interleaved with the normal SSB pattern of the BS. The NCR-specific SSB pattern may include the SSB0 forwarded by the NCR using its 2 beams in turn. From the viewpoint of the UE2 in the serving area of the NCR, the periodicity of the SSB0 can be 20 ms. The UE2 can be provided/configured by ssb-periodicityServingCell of 20 ms to receive the SSBs. The ssb-periodicityServingCell can be provided in the system information (e.g., SIB1), or a UE-specific configuration.

By interleaving the normal SSB pattern and the NCR-specific SSB pattern, the problem 1 can be solved as below.

1. The connection of the UE can be determined in the initial access stage using the RACH resource (or RACH occasion (RO)) associated with each SSB. In FIG. 7, it is observed that the SSB0 shows up three times in a 20 ms periodicity, with the offsets of {0, 5, 15} ms, respectively. Similar to a normal time division multiplexed (TDMed) SSBs transmitted by the BS, the corresponding time frequency resource for cell-common signals (e.g., CORESET #0, SIB1, CORESET #0A, SIBx, RO, and/or paging) can also use a time division multiplexed (TDMed) manner.

(1) If a UE's PRACH preamble is received on the RO associated with the SSB0 using the offset Oms (which is not forwarded by the NCR), the BS may determine that the UE is served by itself directly.

(2) If a UE's PRACH preamble is received on the RO associated with the SSB0 using the offset 5 ms or 15 ms (which is forwarded by the NCR's beam0 or beam1 respectively), the BS may determine that the UE is served by the NCR's beam0 or beam1 at first. The BS may indicate the NCR to forward the following Msg2 and Msg4 with its beam0 or beam1 to help the UE access the network. Since the UE may receive the SSB0 from the BS directly, it can be necessary to determine the UE's connection after the UE's initial access. This will be described in the following mobility support part.

2. The UE's mobility among the BS and NCRs can be supported using enhanced beam measurement using the SSB0 from the BS and the NCR. It is observed that the SSB0 shows up three times in a 20 ms periodicity, with the offsets of {0, 5, 15} ms (or subframe), respectively. If the UE accesses the network using the RO associated with the SSB0 using the offset 5 ms or 15 ms (which is forwarded by the NCR's beams), the BS may determine whether the UE is served by itself directly or by the NCR. To achieve this goal, the UE may measure the SSB0's quality with different offsets.

(1) The UE can be provided an extra/supplemental synchronization signal/physical broadcast channel (PBCH) block (SSB) measurement timing configuration (SMTC) (e.g., called smtc5), in the measurement object. Similar to smtc1, the smtc5 can include periodicity, a list of offsets, and the applicable SSB indexes. However, considering the signaling cost, the supplemental SMTC (e.g., smtc5) may further comprise at least one of: a list of offsets, an identification of one or more of the SSBs; or an association between the offsets and the one or more of the SSBs to be measured. In some embodiments, the supplemental SMTC (e.g., smtc5) may further comprise a list of offsets. The periodicity of SSB for measurement can be provided by a RRC parameter MeasConfig->MeasObjectToAddModList->MeasObjectNR->SSB-MTC->periodicityAndOffset. The periodicity of SSB0 from the viewpoint of the UE can be 20 ms. The offsets corresponding to the BS's beam and the NCR's beams can be {0, 5, 15} ms, respectively. Since one of the offset (e.g., Oms) can be provided in the smtc1, the other offsets (e.g., {5, 15} ms) can be included in the smtc5 to save signaling cost. The periodicity in smtc1 can be omitted in smtc5. In some embodiments, the supplemental SMTC (e.g., smtc5) may further comprise an identification of one or more of the SSBs (e.g., SSB to be measured). Since the SSBs to be forwarded by the NCR is known by the BS, the corresponding SSB indexes can be provided in a list (e.g., called ssb-ToMeasure). With this information, the UE may determine that the SSBs which have multiple offsets and multiple measurement results may be utilized. In some embodiments, the supplemental SMTC (e.g., smtc5) may further comprise an association between the offsets and the one or more of the SSBs to be measured. The association between the offset list and the SSB index can be determined as below.

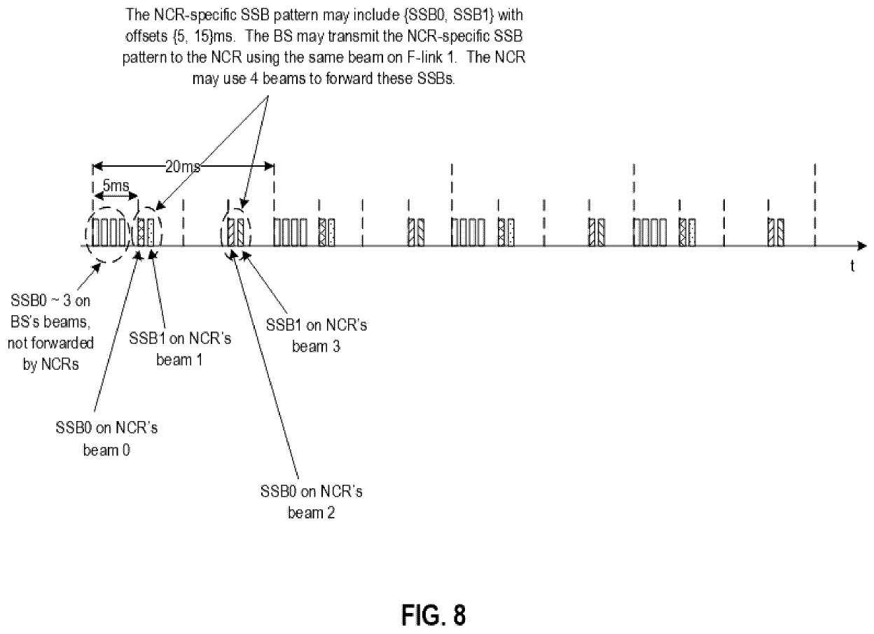

(i) A same list of offsets can be applied to all (or each) the SSBs listed in the ssb-ToMeasure. In such case, the parameter format for smtc5 can be {list-Offsets, ssb-ToMeasure}. For example, the NCR may have 4 beams to forward SSB0 and SSB1 in turn. As illustrated in FIG. 8, the NCR-specific SSB pattern may include SSB0 and SSB1 with common offsets of {5, 15} ms. Therefore, the smtc5 can include {{5,15} ms, {SSB0, SSB1}}.

(ii) For each SSB in the ssb-ToMeasure, a dedicated list of offsets can be applied. In such case, the parameter format for smtc5 can be {SSB(0), list-Offsets(0), SSB(1), list-Offsets(1), . . . SSB(NSSB,max−1), list-Offsets(NSSB,max−1)}, with NSSB,max≤NSSB, where NSSB is the number of SSBs transmitted by the BS. Continuing with the example in FIG. 8, an alternative format the smtc5 can be {SSB0, {5,15} ms, SSB1, {5,15} ms}.

(2) The measurement procedure using the smtc5 can be carried out as below. The example shown in FIG. 7 is used for illustration. For a UE served by the BS, it can be also provided the smtc5 by the BS, if the UE's mobility between the BS and the NCR is to be supported. In the SSB measurement configuration smtc1, the UE can be provided a periodicityAndOffset of value 0 (which is the offset corresponding to the BS's beam) with a choice of sf20 (which is the periodicity of 20 subframes). In smtc5, the UE can be provided a list of offsets of values {5, 15} (which are the offsets corresponding to the NCR's beams). Additionally, in smtc5, the UE can be provided the SSB index 0 to indicate the SSB to be measured with the offset list. For the measurement results report based on smtc5, following methods can be used.

(i) A result list can be added in the MeasurementReport, which may include multiple measurement results for a given reference signal (e.g., SSB). In the present disclosure, the measurement result based on a given SSB can be provided in MeasurementReport->MeasResults->MeasResultServMOList->MeasResultServMO->MeasResultNR->ResultsPerSSB-IndexList->ResultsPerSSB-Index->MeasQuantityResults. To support multiple measurement results per SSB for each of the SSBs listed in the smtc5, the MeasQuantityResults can be replaced by MeasQuantityResultsList->MeasQuantityResults.

a. The number of MeasQuantityResults in the MeasQuantityResultsList can be determined by a total number of offsets provided by smtc1 and smtc5. Each of the MeasQuantityResults can be associated with the offsets provided in the smtc1 and smtc5 in a sequential manner. The structure of the measurement result can be:

ResultsPerSSB-Index ::= SEQUENCE {
ssb-Index SSB-Index,
ssb-ResultsList MeasQuantityResultsList
}
MeasQuantityResultsList ::= SEQUENCE (SIZE
(1..maxNrofOffsets)) OF MeasQuantityResults

The parameter maxNrofOffsets can be a configured value which may indicate the maximum number of offsets that is applicable to a single SSB. In the example of FIG. 7, three MeasQuantityResults can be included in the MeasQuantityResultsList for the SSB0 corresponding to the three offsets {0, 5, 15} ms sequentially. The UE may obtain the first MeasQuantityResults with the information in the smtc1 to measure the SSB0 on the BS's beam with periodicity 20 ms and offset Oms. The UE may obtain the second MeasQuantityResults with the information provided in the smtc1 and smtc5 to measure the SSB0 on the NCR's beam0 with periodicity 20 ms and offset 5 ms. The UE may obtain the third MeasQuantityResults with the information provided in the smtc1 and smtc5 to measure the SSB0 on the NCR's beam1 with periodicity 20 ms and offset 15 ms. Then the UE may report the three SSB0 measurement results using the MeasQuantityResultsList, if at least one of the MeasQuantityResults exceeds the threshold for measurement reporting.

b. The number of MeasQuantityResults in the MeasQuantityResultsList can be determined by the number of MeasQuantityResults that exceeds the threshold for measurement reporting, which can be no more than the total number of offsets provided by smtc1 and smtc5. In such case, the corresponding offset(s) can be included. The structure of the measurement result can be:

ResultsPerSSB-Index ::= SEQUENCE {
ssb-Index SSB-Index,
ssb-Offset SSB-Offset,
ssb-ResultsList MeasQuantityResultsList
}
MeasQuantityResultsList ::= SEQUENCE (SIZE
(1..maxNrofOffsets)) OF MeasQuantityResults

The value range of the parameter ssb-Offset can be determined by the offsets provided in the smtc1 and smtc5 for the corresponding SSB index. The parameter maxNrofOffsets can be a configured value which may indicate the maximum number of offsets that is applicable to a single SSB. In the example of FIG. 7, at most three MeasQuantityResults can be included in the MeasQuantityResultsList for SSB0. The UE may obtain the first MeasQuantityResults with the information in the smtc1 to measure the SSB0 on the BS's beam with periodicity 20 ms and offset Oms. The UE may obtain the second MeasQuantityResults with the information provided in the smtc1 and smtc5 to measure the SSB0 on the NCR's beam0 with periodicity 20 ms and offset 5 ms. The UE may obtain the third MeasQuantityResults with the information provided in the smtc1 and smtc5 to measure the SSB0 on the NCR's beam1 with periodicity 20 ms and offset 15 ms. Then the UE may report the SSB0 measurement results which exceeds the threshold for measurement reporting using the MeasQuantityResultsList, and may fill in the corresponding offset.

(ii) The ResultsPerSSB-IndexList in the MeasurementReport can be reused/re-purposed to report multiple measurement results for a given reference signal (e.g., SSB) with a given index (e.g., SSB0), where a new association with the offsets can be utilized. In the present disclosure, the measurement result based on a given SSB can be provided in MeasurementReport->MeasResults->MeasResultServMOList->MeasResultServMO->MeasResultNR->ResultsPerSSB-IndexList->ResultsPerSSB-Index->MeasQuantityResults. The ResultsPerSSB-IndexList can be a sequence with multiple ResultsPerSSB-Index. Each ResultsPerSSB-Index may include an SSB index and a corresponding measurement result.

```
ResultsPerSSB-IndexList ::= SEQUENCE (SIZE
(1..maxNrofIndexesToReport2)) OF ResultsPerSSB-Index
ResultsPerSSB-Index ::= SEQUENCE {
  ssb-Index SSB-Index,
  ssb-Results MeasQuantityResults
}
```

a. In multiple ResultsPerSSB-Index, the SSB index can be the same, if the SSB is included in the smtc5. The MeasQuantityResults can be used to report the measurement result for the same SSB but from different beams. For a given SSB included in smtc5, the number of ResultsPerSSB-Index can be determined by a total number of offsets provided by smtc1 and smtc5, if at least one of the MeasQuantityResults exceeds the threshold for measurement reporting. In such case, the multiple ResultsPerSSB-Index for the SSB can be associated with the offsets provided in the smtc1 and smtc5 in a sequential manner. In the example of FIG. 7, three ResultsPerSSB-Index in the ResultsPerSSB-IndexList can be used for SSB0. The UE may obtain the first MeasQuantityResults with the information in the smtc1 to measure the SSB0 on the BS's beam with periodicity 20 ms and offset 0 ms. The UE may obtain the second MeasQuantityResults with the information provided in the smtc1 and smtc5 to measure the SSB0 on the NCR's beam0 with periodicity 20 ms and offset 5 ms. The UE may obtain the third MeasQuantityResults with the information provided in the smtc1 and smtc5 to measure the SSB0 on the NCR's beam1 with periodicity 20 ms and offset 15 ms. Then the UE may report the three SSB0 measurement results using the ResultsPerSSB-IndexList, if any one of the measurement results exceeds the threshold for measurement reporting.

b. In multiple ResultsPerSSB-Index, the SSB index can be the same, if the SSB is included in the smtc5. The MeasQuantityResults can be used to report the measurement result for the same SSB but from different beams. For a given SSB included in smtc5, the number of ResultsPerSSB-Index can be determined by the number of MeasQuantityResults that exceeds the threshold for measurement reporting, which can be no more than the total number of offsets provided by smtc1 and smtc5. In such case, the corresponding offset(s) can be included. The structure of the measurement result can be:

ResultsPerSSB-Index ::= SEQUENCE {
ssb-Index SSB-Index,
ssb-Offset SSB-Offset,
ssb-ResultsList MeasQuantityResults
}

In the example of FIG. 7, at most three ResultsPerSSB-Index can be included in the ResultsPerSSB-IndexList for SSB0. The UE may obtain the first ResultsPerSSB-Index with the information in the smtc1 to measure the SSB0 on the BS's beam with periodicity 20 ms and offset Oms. The UE may obtain the second ResultsPerSSB-Index (e.g., from the BS) with the information provided in the smtc1 and smtc5 to measure the SSB0 on the NCR's beam0 with periodicity 20 ms and offset 5 ms. The UE may obtain the third ResultsPerSSB-Index with the information provided in the smtc1 and smtc5 to measure the SSB0 on the NCR's beam1 with periodicity 20 ms and offset 15 ms. Then the UE may report the SSB0 measurement results (e.g., to the BS directly, or through a communication node/NCR) which exceeds the threshold for measurement reporting using multiple ResultsPerSSB-Index fields, and may fill in the corresponding offset.

(3) From the viewpoint of the BS, the three (or less than three—depending on the number of offset(s)) SSB0 measurement results can be used to determine whether the UE is served by the BS itself or by the NCR. If the UE is served by the NCR, the beam used by the NCR can be also determined by the SSB0 measurement results.

### Implementation Example 2

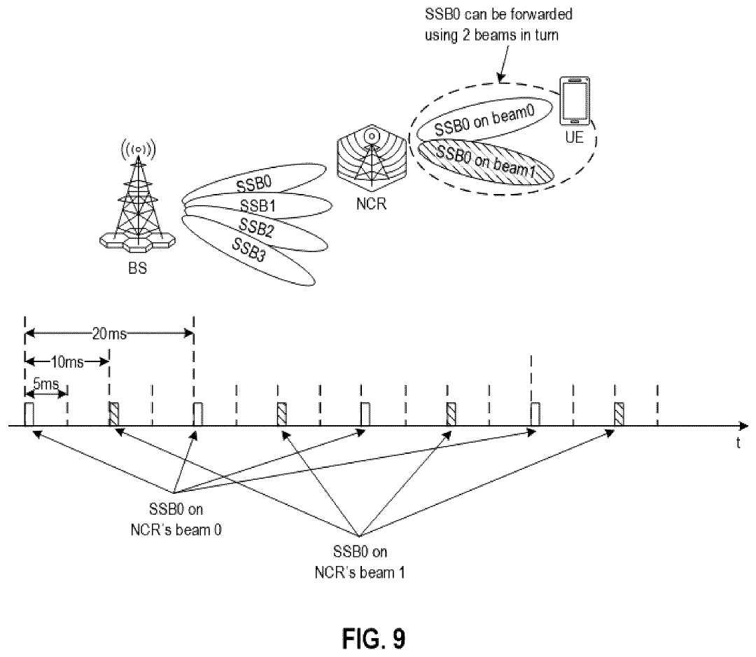

To solve the problem 2, a different periodicity can be used by the NCR forwarded common signaling. As illustrated in FIG. 9, the BS may transmit the SSB0 (which is forwarded by the NCR) using a periodicity of 10 ms, while the BS may transmit all other SSBs (which are not forwarded by any NCR) with the periodicity of 20 ms. Then the SSB0 can be forwarded by the NCR using its 2 beams in turn. From the viewpoint of the UE, the periodicity of the SSB0 can be 20 ms. The UE can be provided by ssb-periodicityServingCell of 20 ms to receive the SSBs.

From the viewpoint of the NCR-MT, the SSB measurement may perform some enhancements. In the present disclosure, the periodicity of SSB for measurement can be provided by the RRC parameter MeasConfig->MeasObjectToAddModList->MeasObjectNR->SSB-MTC->periodicityAndOffset. However, the periodicity provided in SSB-MTC may apply for all SSBs in the indicated measurement duration. As shown in the example above, the SSB0 may have a periodicity of 10 ms, while all other SSBs may have a periodicity of 20 ms. In such case, the NCR-MT can use 10 ms periodicity for SSB0 measurement and 20 ms periodicity for all other SSBs measurement. To achieve this goal, the NCR-MT can be provided with an NCR-specific SSB periodicity for the SSB(s) with the different (non-10 ms) periodicity. The NCR-MT may use this NCR-specific SSB periodicity to calculate the corresponding offset for the SSB(s) with the different periodicity. Then the NCR-MT may use the NCR-specific SSB periodicity and the calculated offset in the SSB measurement for the corresponding SSB(s). The format of the parameters can be at least one of following.

1. {ncr-ssb-periodicityServingCell, ssb-ToMeasure}, where ssb-ToMeasure is a bitmap to indicate the SSBs with the periodicity of ncr-ssb-periodicityServingCell. Each of the parameters can be provided by the BS using a radio resource control (RRC)/medium access control (MAC) control element (CE)/downlink control information (DCI) or determined by a Operations, Administration and Maintenance (OAM). The bitwidth of ssb-ToMeasure may depend on the total number of SSBs used by the BS. For example, in the present disclosure, 4, 8 or 64 SSBs can be supported in different frequency range, which may correspond to the parameter ssb-ToMeasure of a bitmap with 4, 8 or 64. In the bitmap, the first/leftmost bit may correspond to SSB0, the second bit may correspond to SSB1, and so on. Value 1 in the bitmap may indicate that the corresponding SSB is to be measured with the provided ncr-ssb-periodicityServingCell. Value 0 in the bitmap may indicate that the corresponding SSB is to be measured using the periodicity provided by legacy parameter periodicityAndOffset. For the example in FIG. 9, the parameters can be {10 ms, ‘1000’}, where ‘1000’ is the bitmap. Alternatively, a variation (in the implementation) can be that: Value 0 in the bitmap ssb-ToMeasure may indicate that the corresponding SSB is to be measured with the provided ncr-ssb-periodicityServingCell. Value 1 in the bitmap may indicate that the corresponding SSB is to be measured using the periodicity provided by legacy parameter periodicityAndOffset. For the example in FIG. 9, the parameters can be {10 ms, ‘0111’}, where ‘0111’ is the bitmap.

2. {ncr-ssb-periodicityServingCell, SSB(0), SSB(1), . . . SSB(NSSB,max−1)}, with NSSB,max≤NSSB, where NSSB is the number of SSBs transmitted by the BS. The SSB(x), with x=0 . . . NSSB,max−1, can be the SSBs with the periodicity of ncr-ssb-periodicityServingCell. Each of the parameters can be provided by the BS using RRC/MAC CE/DCI signaling or determined by OAM signaling. If less than NSSB,max valid SSBs are listed, any one of the valid SSB(x) can be used to fill the following SSB indexes. For the example in FIG. 9, NSSB=4 can be determined by the SSB case that blindly detected by the NCR-MT. A value of NSSB,max≤4 can be configured to the NCR-MT after its initial access, which can be the maximum number of SSBs forwarded by the NCR. If the NSSB,max is not configured to the NCR-MT, a default value of NSSB can be used. If NSSB,max=2 is configured, the parameters can be {10 ms, (0, 0)}, where (0, 0) is the SSB list with only one valid value corresponding to SSB0. If a default NSSB,max=NSSB=4 is used, the parameters can be {10 ms, (0, 0, 0, 0)}, where (0, 0, 0, 0) is the SSB list with only one valid value corresponding to SSB0. Alternatively, a variation can be that: The SSB(x), with x=0 . . . NSSB,max−1, can be the SSBs with the parameter periodicityAndOffset. Other transmitted SSBs which are not included in the SSB(x) may use the periodicity of ncr-ssb-periodicityServingCell. In addition, a configurable parameter (e.g., a flag with value 0 or 1) in the same signaling can be used to indicate the {SSB(0), SSB(1), . . . SSB(NSSB,max−1)} uses ncr-ssb-periodicityServingCell or periodicityAndOffset.

3. {ncr-ssb-periodicityServingCell, SSB(0), SSB(1), . . . SSB(NSSB,max−1), NSSB,valid}. In this combination, the N_{SSB,valid} can be used to indicate the number of valid SSBs in the list. Thus the NCR may be aware that the first (or last) N_{SSB,valid} SSB(x) values are valid and can ignore the following/other invalid ones. Each of the parameters can be provided by the BS using a RRC/MAC CE/DCI signaling or determined by an OAM signaling. For the example in FIG. 9, N_{SSB}=4 can be determined by the SSB case that blindly detected by the NCR-MT. A value of N_{SSB,max}≤4 can be configured to the NCR-MT after its initial access, which can be the maximum number of SSBs forwarded by the NCR. If the N_{SSB,max} is not configured to the NCR-MT, a default value of N_{SSB,max}=N_{SSB} can be used. If N_{SSB,max}=2 is configured, the parameters can be {10 ms, (0, x), 1}, where (0, x) is the SSB list with only one (indicated by the following value 1) valid value corresponding to SSB0. If a default N_{SSB,max}=N_{SSB}=4 is used, the parameters can be {10 ms, (0, x, x, x), 1}, where (0, x, x, x) is the SSB list with only one (indicated by the following value 1) valid value corresponding to SSB0. Alternatively, the {SSB(0), SSB(1), . . . SSB(NSSB,max−1)} and NSSB,valid can be used to indicate the SSBs which use the legacy parameter periodicityAndOffset. Other transmitted SSBs which are not included in the SSB(x) may use the periodicity of ncr-ssb-periodicityServingCell. In addition, a configurable parameter (e.g., a flag with value 0 or 1) in the same signaling can be used to indicate that the {SSB(0), SSB(1), . . . SSB(NSSB,max−1)} uses ncr-ssb-periodicityServingCell or periodicityAndOffset.

The offset calculation may follow formula: mod(offset provided in periodicityAndOffset, ncr-ssb-periodicityServingCell). In the example shown in FIG. 9, the NCR-MT can be provided the parameters of ncr-ssb-periodicityServingCell=10 ms, and one valid SSB index of SSB0. In the SSB measurement configuration, the NCR-MT can be provided a periodicityAndOffset of value 0 (which is the offset) with a choice of sf20 (which is the periodicity). The NCR may be aware that the periodicity for SSB measurement is 20 subframe (i.e., 20 ms), and the offset is zero subframe. The NCR may calculate the offset of SSB0 measurement by mod(0, 10 ms) to obtain a valid offset value of 0 (unit is subframe or ms). The NCR may carry out the SSB measurement for SSB0 using the periodicity of 10 ms, which is provided by ncr-ssb-periodicityServingCell, and the calculated offset of Oms.

From the viewpoint of the UE, the SSB measurement may utilize an enhancement to support more than one measurement for SSB0. In the present disclosure, for all SSB based measurements, there can be at most one measurement object with the same ssbFrequency. As shown in FIG. 9, to support beam management for possible UE movement among the BS and the NCR's different beams, the UE may measure several SSB0 quantities. To achieve this goal, following method can be used.

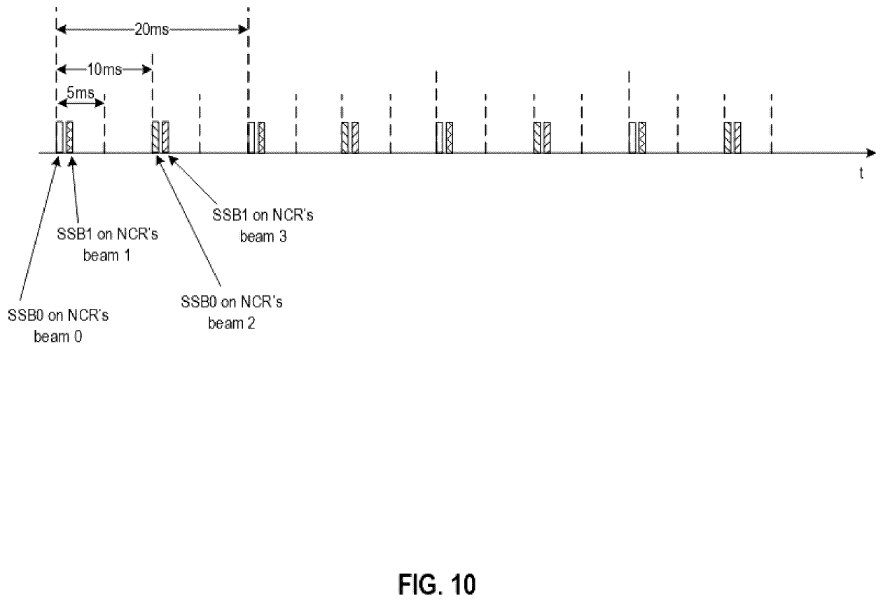

1. An extra SMTC (e.g., called smtc5) can be added in the measurement object. Similar to the smtc1, the smtc5 can include periodicity, a list of offsets, and/or the applicable SSB indexes. However, considering the signaling cost, at least one of following information can be provided in smtc5. In some embodiments, the supplemental SMTC (e.g., smtc5) may further comprise a list of offsets. The periodicity of SSB for measurement can be provided by the RRC parameter MeasConfig->MeasObjectToAddModList->MeasObjectNR->SSB-MTC->periodicityAndOffset. As shown by the example in FIG. 9, the periodicity of SSB0 from the viewpoint of the UE can be 20 ms. However, the offsets corresponding to the 2 NCR's beams can be {0, 10} ms (or subframe), respectively. Since one of the offsets can be provided in the smtc1, the other offsets can be included in the smtc5 to save signaling cost. In some embodiments, the supplemental SMTC (e.g., smtc5) may further comprise an identification of one or more of the SSBs (e.g., SSB to be measured). Since the SSBs to be forwarded by the NCR can be awared by the BS, the corresponding SSB indexes can be provided in a list (e.g., called ssb-ToMeasure). With this information, the extra measurement effort at the UE side can be limited to the NCR forwarded SSBs. In some embodiments, the supplemental SMTC (e.g., smtc5) may further comprise an association between the offsets and the one or more of the SSBs to be measured. The association between the offset list and the SSB index can be determined as below.
(i) A same list of offsets can be applied to all the SSBs listed in the ssb-ToMeasure. In such case, the parameter format for smtc5 can be {list-Offsets, ssb-ToMeasure}. For example, the NCR may have 4 beams to forward SSB0 and SSB1 in turn. As illustrated in FIG. 10, the NCR-specific SSB pattern may include SSB0 and SSB1 with common offsets of {0, 10} ms. Therefore, the smtc5 can include {{0, 10} ms, {SSB0, SSB1}}.
(ii) For each SSB in the ssb-ToMeasure, a dedicated list of offsets can be applied. In such case, the parameter format for smtc5 can be {SSB(0), list-Offsets(0), SSB(1), list-Offsets(1), . . . SSB(NSSB,max−1), list-Offsets(NSSB,max−1)}, with NSSB,max≤NSSB, where NSSB is the number of SSBs transmitted by the BS. Continuing with the example in FIG. 10, an alternative format for the smtc5 can be {SSB0, {0, 10} ms, SSB1, {0, 10} ms}.

2. The measurement procedure using the smtc5 can be carried out as below. The example shown in FIG. 9 is used for illustration.

(1) In the SSB measurement configuration, the UE can be provided a periodicityAndOffset of value 0 (which is the offset corresponding to the BS's beam) with a choice of sf20 (which is the periodicity). In smtc5, the UE can be provided a list of offsets of value {0, 10}(which are the offsets corresponding to the NCR's beams). In smtc5, the UE can be provided the SSB index 0 to indicate the SSB to be measured with the offset list.

(2) For the measurement results report based on smtc5, the same method in implementation example 1 can be used. The only difference is that the offsets provided in the smtc and smtc5 may have repeated values. For example, smtc1 may provide 20 ms periodicity and Oms offset, and smtc5 provides {0, 10} ms offsets. The offset of Oms can be repeated value in smtc1 and smtc5. In such case, the corresponding number of measurement results can be determined by the min(number of unique offsets, number of measurement results exceeding the threshold). In the example mentioned above, the number of unique offsets may equal to 2 (e.g., only 2 unique values of {0, 10}). If the measurement results exceeding the threshold are reported, the corresponding offsets can be reported together with the measurement results as in the implementation example 1's measurement procedure.

It should be understood that one or more features from the above implementation examples are not exclusive to the specific implementation examples and/or embodiments, but can be combined in any manner (e.g., in any priority and/or order, concurrently or otherwise).

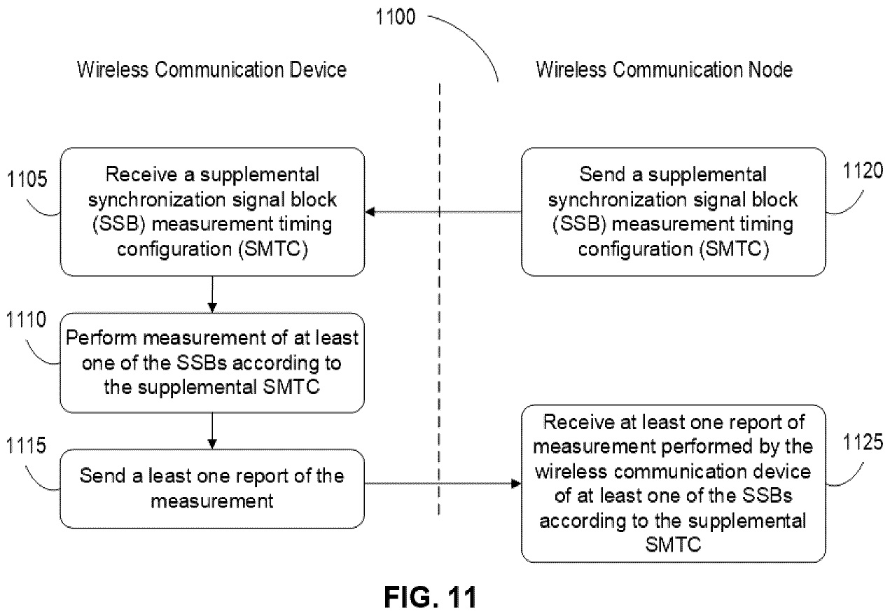

FIG. 11 illustrates a flow diagram of a method 1100 for synchronization signal block (SSB) enhancement. The method 1100 may be implemented using any one or more of the components and devices detailed herein in conjunction with FIGS. 1-2. In overview, the method 1100 may be performed by a wireless communication device, in some embodiments. Additional, fewer, or different operations may be performed in the method 1100 depending on the embodiment. At least one aspect of the operations is directed to a system, method, apparatus, or a computer-readable medium.

A wireless communication device (e.g., a UE) may receive a supplemental synchronization signal block (SSB) measurement timing configuration (SMTC) (e.g., SMTC5) from a wireless communication node (e.g., a BS). The wireless communication device may perform measurement of at least one of a plurality of SSBs according to the supplemental SMTC. The wireless communication device may send at least one report of the measurement to the wireless communication node. Enable multiple measurements (from different communication nodes) for a single SSB may reuse the SSB indexes and may have less impact on a SSB mapping to other associated common channels.

In some embodiments, the SSBs can be transmitted by a communication node configured to at least one of: receive, amplify, send or forward at least one SSB from the wireless communication node. The SSBs (e.g., from the communication node), and at least one SSB from the wireless communication node (e.g., BS), may have transmission occasions that are interleaved in time domain and/or across a number of periodic cycles. In some embodiments, the SSB can be forwarded by a NCR and can be time division multiplexed (TDMed) with non-forwarded SSB. The TDMed SSBs may allow separate measurements of a same SSB index.

In some embodiments, the supplemental SMTC may further comprise at least one of: a list of offsets (e.g., of transmission occasions/resources of SSBs, relative to a reference); an identification of one or more of the SSBs; or an association between the offsets and the one or more of the SSBs to be measured. To enable the measurement for a single SSB from different beams, a SMTC5 may comprise at least one of: a list of offsets; an identification of one or more of the SSBs; or an association between the offsets and the one or more of the SSBs to be measured. In some embodiments, the supplemental SMTC may indicate or configure that: the list of offsets can be applied to the one or more of the SSBs; or a respective list of offsets can be applied to each of the one or more of the SSBs.

In some embodiments, the wireless communication device may receive a first SMTC (e.g., SMTC1) from the wireless communication node. The first SMTC may comprise an indication of at least one of: at least one offset of a SSB from the wireless communication node; or a periodicity of the SSB from the wireless communication node. The periodicity can be same as that of the plurality of SSBs, the plurality of SSBs can be from a network node; or the supplemental SMTC may exclude an indication of the periodicity of the plurality of SSBs.

In some embodiments, the report may include a list (e.g., MeasQuantityResultsList->MeasQuantityResults) which includes one or more measurements results for each of the SSBs that is identified in the supplemental SMTC for measurement. Each of one or more measurements results for one of the SSBs can be associated with offsets of the one of the SSBs in a sequential manner. A maximum number of offsets applicable to a single SSB can be configured via a defined parameter (e.g., maxNrofOffsets). The list may include one or more measurements results that each meets a defined threshold for measurement reporting. The report may include an indication of one of more offsets corresponding to the one or more measurements results that each meets the defined threshold. The list may include a maximum number of measurements results that is at most equal to a total number of offsets for a SSB provided by a first SMTC (e.g., SMTC1) and the supplemental SMTC (e.g., SMTC5).

In some embodiments, each of the SSB may include a common signal. The common signal may comprise at least one of: a synchronization signal/physical broadcast channel block, a control resource set (CORESET), a system information block (SIB), random access channel signal, or a paging signal. A number of measurements results in the report may correspond to a minimum number between: a number of unique offsets for a SSB, and a number of measurement results for the SSB exceeding a defined threshold for measurement reporting.

In some embodiments, a communication node (e.g., a NCR-MT) can be configured with a periodicity for SSBs of the communication node, that is different from (e.g., 20 ms or 10 ms) a periodicity of a SSB of the wireless communication node. The communication node may determine offsets for the SSBs of the communication node, according to the periodicity for the SSBs of the communication node. The communication node may perform measurement of the SSBs of the communication node, using the determined offset and the configured periodicity. The communication node may receive a configuration comprising: the configured periodicity (e.g., ncr-ssb-periodicityServingCell), and an identification of one or more of the SSBs to be measured (e.g., ssb-ToMeasure) by the communication node, to which the configured periodicity applies. In some embodiments, the identification may comprise a bitmap with each bit indicating whether a corresponding SSB is to be measured. A bitwidth of the bitmap can be a total number of SSBs of the wireless communication node. The bitmap may comprise bits corresponding in sequence to indexes of the one or more SSBs.

In some embodiments, the identification may comprise indexes of the one or more SSBs is to be measured. A maximum number of the indexes of the one or more SSBs can be to be measured, is same as a number of SSBs transmitted by the wireless communication node. The communication node may receive one or more parameters of the configuration from the wireless communication node via at least one of: a radio resource control (RRC) signaling, a medium access control control element (MAC CE) signaling, a downlink control information (DCI) signaling, or an operations, administration and maintenance (OAM) signaling. The configuration may include an indication of a number of valid SSBs, which identifies first or last SSBs in order of their indexes, that are valid. In some embodiments, the communication node may determine the offsets using a modulo function (e.g., mod(offset provided in periodicityAndOffset, ncr-ssb-periodicityServingCell)) applied on: an offset provided in a periodicityAndOffset parameter, and the configured periodicity.

In some embodiments, a wireless communication node (e.g., a BS) may send a supplemental synchronization signal block (SSB) measurement timing configuration (SMTC) (e.g., SMTC5) to a wireless communication device (e.g., a UE). The wireless communication node may receive at least one report of measurement performed by the wireless communication device of at least one of a plurality of SSBs according to the supplemental SMTC from wireless communication device.

While various embodiments of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described illustrative embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present solution.

Additionally, memory or other storage, as well as communication components, may be employed in embodiments of the present solution. It will be appreciated that, for clarity purposes, the above description has described embodiments of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the embodiments described in this disclosure will be readily apparent to those skilled in the art, and the general principles defined herein can be applied to other embodiments without departing from the scope of this disclosure. Thus, the disclosure is not intended to be limited to the embodiments shown herein, but is to be accorded the widest scope consistent with the novel features and principles disclosed herein, as recited in the claims below.

1. A method comprising:
receiving, by a wireless communication device from a wireless communication node, a supplemental synchronization signal block (SSB) measurement timing configuration (SMTC);
performing, by the wireless communication device, measurement of at least one of a plurality of SSBs according to the supplemental SMTC; and
sending, by the wireless communication device to the wireless communication node, at least one report of the measurement.

2. The method of claim 1, wherein the SSBs are transmitted by a communication node configured to at least one of: receive, amplify, send or forward at least one SSB from the wireless communication node.

3. The method of claim 1, wherein the SSBs, and at least one SSB from the wireless communication node, have transmission occasions that are interleaved in time domain.

4. The method of claim 1, wherein the supplemental SMTC further comprises at least one of:
a list of offsets;
an identification of one or more of the SSBs; or
an association between the offsets and the one or more of the SSBs to be measured.

5. The method of claim 4, wherein the supplemental SMTC indicates or configures that:
the list of offsets is applied to the one or more of the SSBs; or
a respective list of offsets is applied to each of the one or more of the SSBs.

6. The method of claim 1, wherein at least one of:
the report includes a list which includes one or more measurements results for each of the SSBs that is identified in the supplemental SMTC for measurement;
each of one or more measurements results for one of the SSBs is associated with offsets of the one of the SSBs in a sequential manner;
a maximum number of offsets applicable to a single SSB is configured via a defined parameter;
the list includes one or more measurements results that each meets a defined threshold for measurement reporting; or
the report includes an indication of one of more offsets corresponding to the one or more measurements results that each meets the defined threshold.

7. The method of claim 1, wherein at least one of:
each of the SSB includes a common signal; or
the common signal comprises at least one of: a synchronization signal/physical broadcast channel block, a control resource set (CORESET), a system information block (SIB), random access channel signal, or a paging signal.

8. The method of claim 6, wherein a number of measurements results in the report corresponds to a minimum number between: a number of unique offsets for a SSB, and a number of measurement results for the SSB exceeding a defined threshold for measurement reporting.

9. The method of claim 1, wherein at least one of:
a communication node is configured with a periodicity for SSBs of the communication node, that is different from a periodicity of a SSB of the wireless communication node;
the communication node determines offsets for the SSBs of the communication node, according to the periodicity for the SSBs of the communication node; or
the communication node performs measurement of the SSBs of the communication node, using the determined offset and the configured periodicity.

10. The method of claim 9, wherein the communication node receives a configuration comprising:
the configured periodicity, and
an identification of one or more of the SSBs to be measured by the communication node, to which the configured periodicity applies.

11. The method of claim 10, wherein at least one of:
the identification comprises a bitmap with each bit indicating whether a corresponding SSB is to be measured;
a bitwidth of the bitmap is a total number of SSBs of the wireless communication node; or
the bitmap comprises bits corresponding in sequence to indexes of the one or more SSBs.

12. The method of claim 10, wherein at least one of:
the identification comprises indexes of the one or more SSBs is to be measured;
a maximum number of the indexes of the one or more SSBs is to be measured, is same as a number of SSBs transmitted by the wireless communication node;
the communication node receives one or more parameters of the configuration from the wireless communication node via at least one of: a radio resource control (RRC) signaling, a medium access control control element (MAC CE) signaling, a downlink control information (DCI) signaling, or an operations, administration and maintenance (OAM) signaling; or
the configuration includes an indication of a number of valid SSBs, which identifies first or last SSBs in order of their indexes, that are valid.

13. The method of claim 10, wherein the communication node determines the offsets using a modulo function applied on: an offset provided in a periodicityAndOffset parameter, and the configured periodicity.

14. A method comprising:
sending, by a wireless communication node to a wireless communication device, a supplemental synchronization signal block (SSB) measurement timing configuration (SMTC); and
receiving, by the wireless communication node from the wireless communication device, at least one report of measurement performed by the wireless communication device of at least one of a plurality of SSBs according to the supplemental SMTC.

15. A wireless communication device comprising:
at least one processor configured to:
receive, via a transceiver from a wireless communication node, a supplemental synchronization signal block (SSB) measurement timing configuration (SMTC);
perform measurement of at least one of a plurality of SSBs according to the supplemental SMTC; and
send, via the transceiver to the wireless communication node, at least one report of the measurement.

16. The wireless communication device of claim 15, wherein the SSBs are transmitted by a communication node configured to at least one of: receive, amplify, send or forward at least one SSB from the wireless communication node.

17. The wireless communication device of claim 15, wherein the SSBs, and at least one SSB from the wireless communication node, have transmission occasions that are interleaved in time domain.

18. The wireless communication device of claim 15, wherein the supplemental SMTC further comprises at least one of:
a list of offsets;
an identification of one or more of the SSBs; or
an association between the offsets and the one or more of the SSBs to be measured.

19. The wireless communication device of claim 18, wherein the supplemental SMTC indicates or configures that:
the list of offsets is applied to the one or more of the SSBs; or
a respective list of offsets is applied to each of the one or more of the SSBs.

20. A wireless communication node comprising:
at least one processor configured to:
send, via a transceiver to a wireless communication device, a supplemental synchronization signal block (SSB) measurement timing configuration (SMTC); and
receive, via the transceiver from the wireless communication device, at least one report of measurement performed by the wireless communication device of at least one of a plurality of SSBs according to the supplemental SMTC.
